(19) United States
(12) Patent Application Publication
(10) Pub. No.: US 2022/0194435 A1
(43) Pub. Date: Jun. 23, 2022

(54) UNMANNED LOGISTICS VEHICLE, TRANSACTION SYSTEM AND METHOD

(71) Applicant: Move-X Autonomous Driving Technology Co., Ltd., Lu'an (CN)

(72) Inventor: Guoliang ZHAO, Lu'an (CN)

(73) Assignee: Move-X Autonomous Driving Technology Co., Ltd., Lu'an (CN)

(21) Appl. No.: 17/478,938

(22) Filed: Sep. 19, 2021

(30) Foreign Application Priority Data
Dec. 21, 2020 (CN) 202011518887.5

(51) Int. Cl. B60W 60/00; B60P 3/00; G06Q 10/06; G06Q 10/08; G06Q 20/32

(52) U.S. Cl. CPC B60W 60/00256; B60P 3/007; G06Q 10/06315; G06Q 10/0835; G06Q 20/326; G06F 3/16; B60W 2420/42; B60W 2540/21; G06Q 20/3276; G06Q 2240/00; B60W 2556/45

(57) ABSTRACT

The present disclosure provides an unmanned logistics vehicle, and a transaction system and method. The unmanned logistics vehicle includes a signal transceiving device in communication with a transaction server and is used for receiving a shipping/pickup request; a central controller for controlling the unmanned logistics vehicle to drive to a designated place according to the shipping/pickup request received by the signal transceiving device; an on-board compartment for placing goods; a display device for displaying information of the goods placed in the on-board compartment. The transaction system includes a shipping-side client terminal, a pickup-side client terminal, a transaction server and the unmanned logistics vehicle, the shipping-side client terminal, the pickup-side client terminal and the unmanned logistics vehicle are in communication with the transaction server. The solution of the present disclosure improves the transaction efficiency and quality, shortens the transaction time and enhances transaction convenience.

### RELATED APPLICATIONS

This application claims the benefit of priority to Chinese Patent Application No. 202011518887.5, filed on Dec. 21, 2020, and the entire contents of which are incorporated herein by reference.

### TECHNICAL FIELD

The present disclosure relates to the field of transaction logistics, in particular to an unmanned logistics vehicle, and a transaction system and method for goods transaction using the unmanned logistics vehicle.

### BACKGROUND

The development of e-commerce and logistics has promoted the trade of goods, and there are more and more second-hand and unused items in people's hands (souvenirs, electronic products, arts and crafts, decorations, calligraphy and painting, daily necessities, sporting goods, etc.). At present, it is common to sell second-hand and unused items on online platforms through the Internet. However, People can only see the photos of the items, not the actual items. Thus, it is in urgent need of an online plus offline platform for buying and selling second-hand and unused items, so as to help people understand the commodity value of the items more accurately.

The existing goods transaction modes mainly include:

1. Online selling platforms, in this mode, people can only see the picture of the item without in person experience. It cannot ensure the authenticity of the item, and is prone to the problem that the received item does not match the expectation. In addition, the transaction may take at least one or two days to complete, making it inefficient.

2. Bricks-and-mortar stores, such as the physical stores that sell used luxury bags and watches. However, these stores have high costs for renting and have limited items in stores.

3. Shared consignment boxes, the boxes are usually mounted at a fixed position, which lacks the mobility to the buyer/seller's destination autonomously. In addition, and the items cannot be updated in time or conveniently.

It can be seen that there are some problems in the existing goods transaction modes, such as low transaction efficiency and the lack of convenience, as well as high costs.

### SUMMARY

The technical problem to be solved by the solutions of the present disclosure is that the existing goods transaction modes have high cost, low transaction efficiency, and are inconvenient, and the like.

In order to solve the above technical problem, the solution of the present disclosure discloses an unmanned logistics vehicle, which includes: a signal transmitting/receiving device in communication with a transaction server to receive a target request, the target request being at least one of a shipping request or a pickup request; a central controller to control the unmanned logistics vehicle to drive to a designated place according to the target request received by the signal transmitting/receiving device; an on-board compartment to store goods; and a display device to display information of the goods placed in the on-board compartment.

In order to solve the above technical problem, the solution of the present disclosure further discloses a transaction system, which includes: a shipping-side client terminal; a pickup-side client terminal; a transaction server; and an unmanned logistics vehicle, wherein the shipping-side client terminal, the pickup-side client terminal and the unmanned logistics vehicle are each in communication with the transaction server, the transaction server receives a shipping request of the shipping-side client terminal and forwards the shipping request to the unmanned logistics vehicle, the unmanned logistics vehicle receives the shipping request from the transaction server, drives to a first place designated by the shipping-side client terminal to place goods on the unmanned logistics vehicle, the transaction server further receives a pickup request from the pickup-side client terminal and forwards the pickup request to the unmanned logistics vehicle with the goods, the unmanned logistics vehicle with the goods receives the pickup request from the transaction server and drives to a second place designated by the pickup-side client terminal, and the unmanned logistics vehicle, includes: a signal transceiving device in communication with the transaction server to receive the shipping request or the pickup request, a central controller to control the unmanned logistics vehicle to drive to the first place according to the shipping request or the second place according to the pickup request received by the signal transceiving device; an on-board compartment to store the goods; and a display device to display information of the goods placed in the on-board compartment.

In order to solve the above technical problem, the solution of the present disclosure further discloses a transaction method, which includes: sending, by a shipping-side client terminal, a shipping request to a transaction server; receiving, by the transaction server, the shipping request and forwarding, by the transaction server, the shipping request to an unmanned logistics vehicle; receiving, by the unmanned logistics vehicle, the shipping request and driving, by the unmanned logistics vehicle, to a first place designated by the shipping-side client terminal; placing, by a user of the shipping-side client terminal, goods to the unmanned logistics vehicle; sending, by a pickup-side client terminal, a pickup request to the transaction server; receiving, by the transaction server, the pickup request and forwarding, by the transaction server, the pickup request to the unmanned logistics vehicle where the goods are placed; and receiving, by the unmanned logistics vehicle with the goods, the pickup request and driving, by the unmanned logistics vehicle with the goods to a second place designated by the pickup-side client terminal.

Compared with the existing technologies, the technical solution of the present disclosure has the following beneficial effects:

combining the unmanned logistics vehicle with the online transaction platform (client terminal+server) increases offline transaction channels for the online transaction platform, and enables users to know the value of commodities more intuitively, thus improving the transaction efficiency and quality.

In addition, the disclosure of the autonomous driving technology of unmanned logistics vehicles realizes the goods transaction at home, and users can acquire the needed goods on the same day, thus making the transaction more convenient and shortening the transaction time.

Furthermore, employing the combination of the unmanned logistics vehicle and online transaction platforms can not only save the expensive rental cost and labor cost of entity stores, but also better promote the services of online transaction platforms and improve the quality of transaction services through the display of items on offline unmanned logistics vehicles.

### BRIEF DESCRIPTION OF THE DRAWINGS

To illustrate the technical solutions in some exemplary embodiments of the present disclosure, the following will briefly introduce the drawings for the description of some exemplary embodiments. Obviously, the drawings in the following description are merely some exemplary embodiments of the present disclosure, from which other drawings may be obtained without exerting inventive effort by those ordinarily skilled in the art.

FIG. 1 is a structural schematic diagram of a transaction system including an unmanned logistics vehicle according to some exemplary embodiments of the present disclosure;

FIGS. 2 and 3 are structural schematic diagrams of an on-board compartment of an unmanned logistics vehicle according to some exemplary embodiments of the present disclosure;

FIG. 4 is a schematic flow chart of an example of selling goods in a sales transaction process according to some exemplary embodiments of the present disclosure;

FIGS. 5 to 8 are schematic diagrams of examples of a shipping-side client terminal interface in the sales transaction process according to some exemplary embodiments of the present disclosure;

FIG. 9 is a schematic flow chart of an example of purchasing goods in the sales transaction process according to some exemplary embodiments of the present disclosure; and

FIGS. 10 to 12 are schematic diagrams of examples of a pickup-side client terminal interface in the sales transaction process according to some exemplary embodiments of the present disclosure.

### DETAILED DESCRIPTION

The technical solutions in some exemplary embodiments of the present disclosure will be described below in conjunction with the accompanying drawings. Obviously, the described embodiments are only part of embodiments of the present disclosure. Based on some exemplary embodiments of the present disclosure, all other embodiments obtained by those ordinarily skilled in the art without exerting creative effort fall within the scope of protection of the present disclosure.

In the description of the present disclosure, it should be understood that, orientation or positional relationships indicated by terms such as “up”, “down”, “top”, “bottom” are based on the orientation or positional relationships shown in the drawings, for ease of description of the present disclosure and simplification of the description only, these terms do not indicate or imply that the device or element referred to must have a specific orientation or be constructed and operated in a specific orientation, and therefore cannot be construed as limitations to the present disclosure. In addition, the terms of “first”, “second” are for descriptive purposes only and cannot be construed as indicating or implying relative importance or implying the number of the indicated technical features. Thus, features defined with “first” and “second” may explicitly or implicitly include one or more of the features. Moreover, the terms “first”, “second”, etc. are used to distinguish similar objects and are not necessarily to describe a specific order or sequence. It should be understood that the data thus used may be interchanged under appropriate circumstances, so that some exemplary embodiments of the present disclosure described herein can be implemented in an order other than those illustrated or described herein.

With progresses in autonomous driving technology, there are more and more applications for unmanned logistics vehicles (hereinafter may be referred to as unmanned vehicles). The solution of the present disclosure provides an unmanned logistics vehicle, which may replace manpower for goods logistics and commodity sales/rent in certain areas. Furthermore, a client terminal, a transaction server and the unmanned logistics vehicle together may implement an online transaction platform and offline transactions, thereby making transactions more efficient and convenient. Below, the solution of the present disclosure will be described in detail with reference to drawings and some exemplary embodiments.

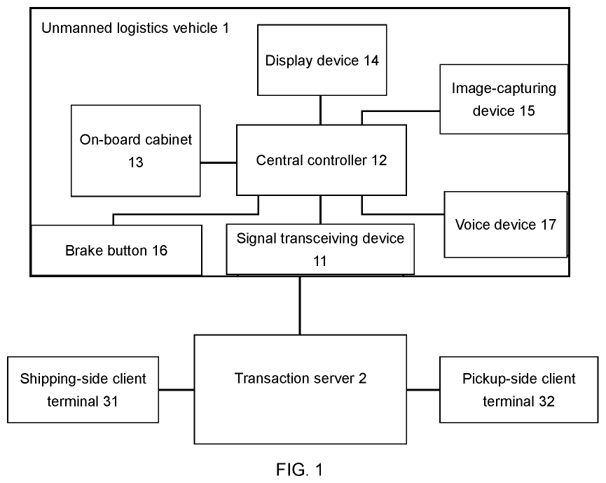

Refer to FIG. 1, an unmanned logistics vehicle 1 of some exemplary embodiments of the present disclosure may include: a signal transmitting/receiving device 11, a central controller 12, an on-board compartment 13 and a display device 14. The signal transmitting/receiving device 11 is in communication with a transaction server 2, and is used for receiving a shipping/pickup request; the central controller 12 is used for controlling the unmanned logistics vehicle 1 to drive to a designated place according to the shipping/pickup request received by the signal transmitting/receiving device 11; the on-board compartment 13 is a storage unit used for storing goods, such as a compartment of the unmanned vehicle; and the display device 14 is used for displaying information of the goods placed in the on-board compartment 13.

The information of goods displayed by the display device 14 includes, but is not limited to, the following information: images/videos, prices, names, specifications (such as weights and sizes) of the goods, etc. The information of the goods may be uploaded to the transaction server 2 by a user through the client terminal, and then transmitted from the transaction server 2 to the central controller 12 through the signal transmitting/receiving device 11. After the goods are placed in the on-board compartment 13, the central controller 12 may control the display device 14 to show information of the goods.

The display device 14 may be a touch screen, which may display images/videos of the goods placed in the on-board compartment 13 during driving, when the user touches or clicks the images/videos of the goods, the touch screen may further display detailed information of corresponding goods. The user may touch or click a selection button (such as a purchase button), and the touch screen may further display the code-scanning payment information of the corresponding goods.

The unmanned logistics vehicle 1 of some exemplary embodiments may further include an image-capturing device 15 for collecting image information of the goods. The image-capturing device 15 may be, for example, a camera mounted on the vehicle; before placing the goods into the compartment, the user may hold the goods up to the camera, so the camera shoots the goods from various directions. It is also possible to set up a display stand within the image-capturing range of the camera, and shoot the goods from various directions by moving and/or rotating the camera and/or the display stand. The image information of the goods shown by the display device 14 may be an image or video of the goods provided by the user, or an image or video of the goods shot by the image-capturing device 15.

Further, the image-capturing device 15 may also be used for collecting image information of the user shipping goods and/or the user picking up goods (i.e., shipping/pickup user), and performing identity authentication on the collected image information of the shipping/pickup user through the central controller 12, the client terminal and the transaction server 2, thereby improving the security of the transaction.

The unmanned logistics vehicle 1 of some exemplary embodiments may further include a physical brake button 16 for triggering the unmanned logistics vehicle to stop/start. Generally, the physical brake button 16 may be disposed outside the body of the unmanned logistics vehicle 1. The unmanned logistics vehicle 1 may travels at a low speed on the road, pedestrians may see the goods placed on the vehicle through the on-board compartment 13 or the display device 14. If there is an item of interest, the physical brake button 16 may be pressed to trigger the central controller 12 to control the vehicle to stop. When the physical brake button 16 is pressed again, it may trigger the central controller 12 to control the vehicle to start.

The unmanned logistics vehicle 1 of some exemplary embodiments may further include a voice device 17 for issuing a voice operation prompt. During the process of placing and taking out goods, the voice device 17 may issue a voice prompt to remind the user to perform corresponding operation.

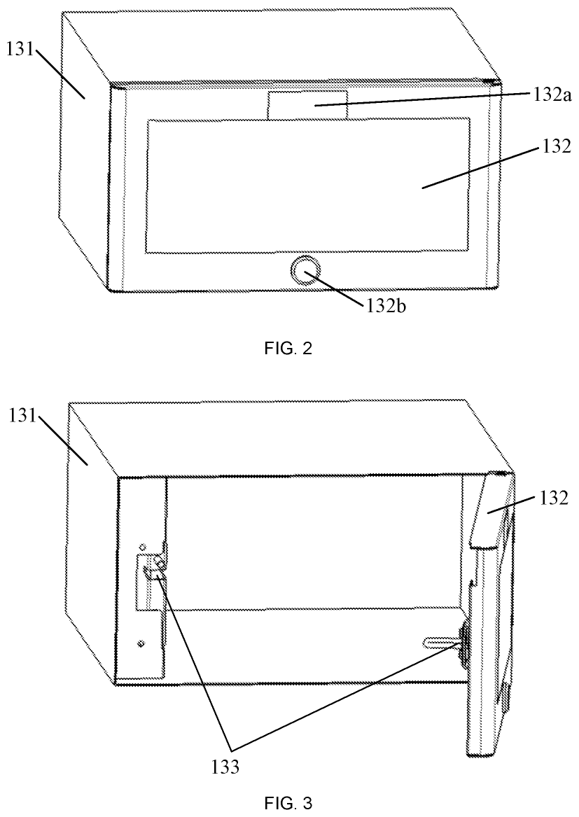

Please refer to the on-board compartment 13 of the unmanned logistics vehicle 1 according to some exemplary embodiments as shown in FIGS. 2 and 3. FIG. 2 shows a state where the compartment door is closed and FIG. 3 shows a state where the compartment door is open. The on-board compartment 13 may include a compartment body 131, a transparent compartment door 132 on which a display 132a and a selection button 132b are integrated, and an electric control lock 133.

The on-board compartment 13 may be a structure composed of a plurality of compartment bodies 131 and a plurality of transparent compartment doors 132, and may be integrally installed in the vehicle. The display 132a may be used for displaying prices of the goods placed in the corresponding compartment body 131 and/or on the compartment door 132. Pressing the selection button 132b indicates that the goods placed in the corresponding compartment body 131 and/or on the compartment door 132 are selected, which may trigger the central controller 12 to control the display device 15 (e.g., a touch screen) to display the payment QR (Quick Response) code of the corresponding goods.

A transaction system according to some exemplary embodiments of the present disclosure may include a shipping-side client terminal 31, a pickup-side client terminal 32, a transaction server 2, and the unmanned logistics vehicle 1; the shipping-side client terminal 31, the pickup-side client terminal 32 and the unmanned logistics vehicle 1 each may be in communication with the transaction server 2.

The transaction server 2 may be used for receiving a shipping request of the shipping-side client terminal 31 and forwarding the request to the unmanned logistics vehicle 1; and the unmanned logistics vehicle 1 may be used for receiving the shipping request from the transaction server 2 and driving to a place designated by the shipping-side client terminal 31 to place goods on the unmanned logistics vehicle 1.

The transaction server 2 may be further used for receiving a pickup request from the pickup-side client terminal 32 and forwarding the request to the unmanned logistics vehicle 1 where the goods are placed; and the unmanned logistics vehicle 1 where the goods are placed may be used for receiving the pickup request from the transaction server 2 and driving to a place designated by the pickup-side client terminal 32 to allow the goods placed on the unmanned logistics vehicle 1 to be picked up.

In some exemplary embodiments, the shipping-side client terminal 31 and the pickup-side client terminal 32 may be portable electronic devices or computers in which a transaction service application program is installed. Users may use the portable electronic device, such as a mobile phone, or a tablet computer, in which a transaction application (APP) is installed, to conduct online transactions. Users may also use a computer in which client terminal software of the transaction service is installed to conduct online transactions. The transaction service application program installed in the shipping-side client terminal 31 and the pickup-side client terminal may be the same; or they may be different, such as programs being customized for different user groups, for example, a seller/merchant client terminal application, a buyer client terminal application, etc.

With reference to FIG. 1, the transaction method of some exemplary embodiments of the present application may include: the shipping-side client terminal 31 sending the shipping request to the transaction server 2; the transaction server 2 receiving the shipping request and forwarding the request to the unmanned logistics vehicle 1; the unmanned logistics vehicle 1 receiving the shipping request and driving to the place designated by the shipping-side client terminal 31; a user of the shipping-side client terminal 31 placing goods on the unmanned logistics vehicle 1; the pickup-side client terminal 32 sending the pickup request to the transaction server 2; the transaction server 2 receiving the pickup request and forwarding the request to the unmanned logistics vehicle 1 where the goods are placed; and the unmanned logistics vehicle 1 where the goods are placed receiving the pickup request and driving to the place designated by the pickup-side client terminal 32.

In some exemplary embodiments, the transaction method may further include: the image-capturing device 15 on the unmanned logistics vehicle 1 collecting image information of the user of the shipping-side client terminal 31 and the goods placed by the user.

The transaction method may further include: after the user of the pickup-side client terminal 32 confirms the goods placed on the unmanned logistics vehicle 1, triggering the compartment door of the on-board compartment 13 for placing the goods on the unmanned logistics vehicle 1 to open. The goods placed on the unmanned logistics vehicle 1 may be confirmed by pressing the selection button on the compartment door, or by touching and clicking the selection button of the corresponding goods on the touch screen to trigger the central controller 12 to unlock the electric control lock provided between the corresponding compartment body and the compartment door, thereby opening the compartment door.

The transaction method may further include: after a passer-by/a person sees information of the placed goods from the display device 14 on the unmanned logistics vehicle 1, stopping the vehicle through the physical brake button 16 integrated on the unmanned logistics vehicle 1. Further, the transaction method may further include: after the passer-by/person confirms the goods placed on the unmanned logistics vehicle 1, triggering the compartment door of the on-board compartment 13 for placing the goods on the unmanned logistics vehicle 1 to open.

The unmanned logistics vehicle and the transaction system of some exemplary embodiments of the present disclosure may have a wide range of applications, including but not limited to, the following application scenarios:

1. A seller has an item for sale, and calls a nearby unmanned vehicle through the shipping-side client terminal and the transaction server, that is, sends a shipping request (carrying the seller's location information, etc.); after the unmanned vehicle arrives at the seller's location, the seller unlocks the on-board compartment of the unmanned vehicle and places the item therein, and then closes and locks the compartment door; a buyer searches for whether a nearby unmanned vehicle(s) has an item needed (a target item) through the pickup-side client terminal and the transaction server, upon finding the target items, the buyer calls the unmanned vehicle with the target item through the pickup-side client terminal and the transaction server, that is, sends a pickup request (carrying the buyer's location information, etc.); and after the unmanned vehicle arrives at the buyer's location, the buyer performs an inspection on the target item, presses the selection button when confirming the purchase, unlocks the corresponding compartment door after completing the code scanning payment operation for purchasing, takes out the target item and then closes the compartment door.

2. A lessor has an item for renting, and calls a nearby unmanned vehicle through the shipping-side client terminal and the transaction server, that is, sends a shipping request (carrying the lessor's location information, etc.); when the unmanned vehicle arrives at the lessor's location, the lessor unlocks the on-board compartment of the unmanned vehicle and places the item therein, and then closes and locks the compartment door; a lessee searches for whether a nearby unmanned vehicle(s) has a needed item through the pickup-side client terminal and the transaction server, and upon finding the target item, calls the unmanned vehicle with the target item through the pickup-side client terminal and the transaction server, that is, sends a pickup request (carrying the lessee's location information, etc.); and when the unmanned vehicle arrives at the lessee's location, the lessee performs an inspection on the target item, presses the selection button when confirming the renting, unlocks the corresponding compartment door after completing the code scanning payment operation for renting, takes out the target item and then closes the compartment door.

3. A merchant uploads the sales/rental information of an item to the transaction server through the shipping-side client terminal, and the transaction server displays the sales/rental information of the item to the pickup-side client terminal; the user browses the sale/rental information of the item and selects a target item, the pickup-side client terminal sends a pickup request (carrying a user's location information, etc.); the transaction server informs the merchant, the merchant receives an order, and then calls a nearby unmanned vehicle through the shipping-side client terminal and the transaction server, that is, sends a shipping request (carrying the merchant's location information, etc.); when the unmanned vehicle arrives at the merchant's location, the merchant unlocks the on-board compartment of the unmanned vehicle and places the target item therein, and then closes and locks the compartment door; the unmanned vehicle leaves the location of the merchant and drives to the user's location, the user then performs an inspection on the target item, presses the selection button when confirming the purchasing/renting, unlocks the corresponding compartment door after completing the code scanning payment operation for purchasing/renting, takes out the target goods and then closes the compartment door.

4. A user orders food through a food delivery platform (the merchant's shipping-side client terminal, the transaction server and the user's pickup-side client terminal), and the pickup-side client terminal sends a pickup request (carrying the user's location information, etc.); the merchant receives the order, calls a nearby unmanned vehicle through the shipping-side client terminal and the transaction server after the food is ready, that is, sends a shipping request (carrying the merchant's location information, etc.); when the unmanned vehicle arrives at the merchant's location, the merchant unlocks the on-board compartment of the unmanned vehicle and places the food therein, and then closes and locks compartment door; the unmanned vehicle leaves the location of the merchant and drives to the user's location, the user presses the selection button, unlocks the corresponding compartment door after completing the code scanning payment operation, takes out the meal and then closes the compartment door.

It should be noted that the above payment operation is completed by scanning a code shown on the unmanned vehicle, and the compartment door is opened after the code scanning payment is completed. In some exemplary embodiments, the payment operation may also be completed directly at the client terminal and a verification code may be obtained at the same time. The compartment door is then opened upon verifying the verification code when placing or picking up an item.

The process of applying the unmanned logistics vehicle to perform a goods transaction in some exemplary embodiments of the present disclosure will be illustrated below with reference to the accompanying drawings, and taking the transaction of an unused item as an example.

The transaction system in the example may include an unmanned Logistics Vehicle which may be an autonomous vehicle that may, in a specific application scenario, arrive at a designated location through autonomous driving; a transaction server which may be a background server that uses the unmanned vehicle to transport goods, and is configured to receive, send, store and process information; and a transaction application (APP) which is an application software installed on a mobile phone(s) for online and offline transactions of second-hand or unused items. In this example, a seller's mobile phone with the transaction APP installed corresponds to the shipping-side client terminal, and a buyer's mobile phone with the transaction APP installed corresponds to the pickup-side client terminal.

The unmanned vehicle may include: an on-board compartment which is disposed on the unmanned vehicle and includes a plurality of compartment doors, where each compartment door may store items, the compartment door is integrated with a display screen for displaying prices and a purchase selection button thereon, a door cover plate is made of transparent glass or other transparent materials, and the compartment door is further equipped with an electric control lock, so that a user may open a corresponding compartment door by scanning a code. The unmanned vehicle may further include an unmanned vehicle transmitting/receiving device, which may include an on-board Telematics BOX (T-BOX), 4G/5G/6G mobile communication modules, etc. The transceiving device may receive/send requests and information remotely. The unmanned vehicle may further include a central controller, that is, a central processor integrated in the unmanned vehicle, which is a core unit for information transmitting/receiving, storing, calculation, processing, and decision-making control with other control units on the vehicle; a display device which may include a display screen integrated on the unmanned vehicle (for example, a touch screen) for displaying goods information, QR code information, etc.; an image-capturing device which may include a camera integrated on the unmanned vehicle for recording commodity information and buyer/seller identity information for image information collection; a voice device which may include a speaker integrated on the unmanned vehicle for issuing voice prompts; and a physical brake button integrated on the unmanned vehicle, which may be pressed to stop the vehicle; when the button is pressed again, it will be reset to allow the vehicle to start.

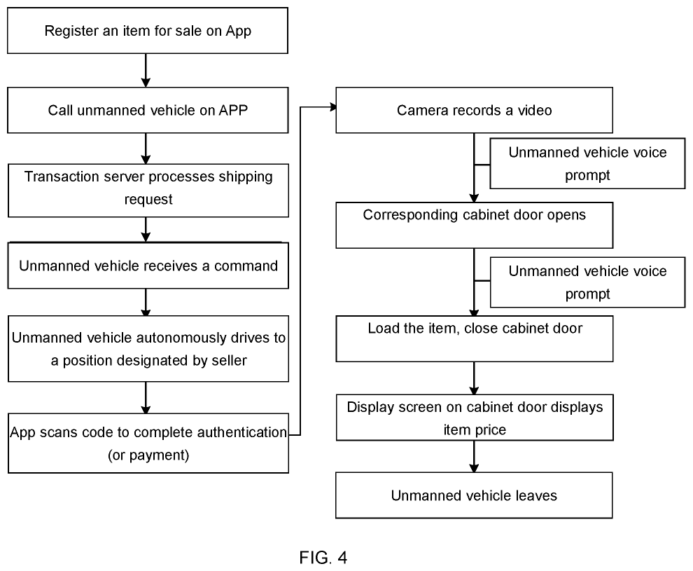

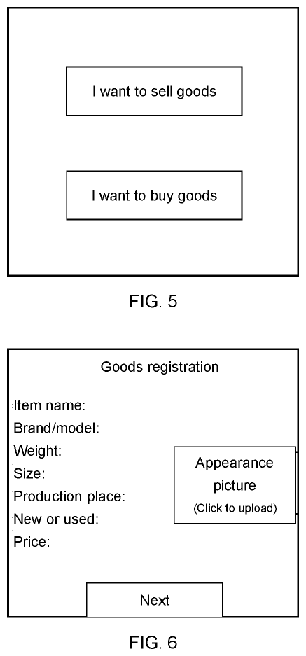

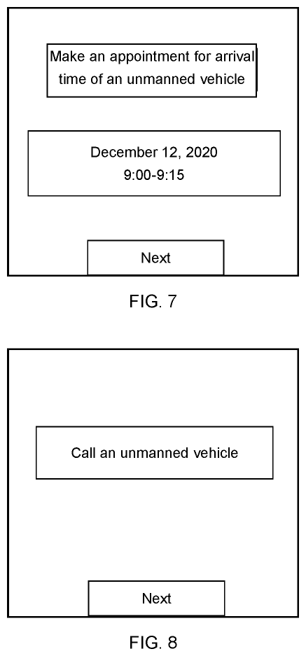

Please refer to FIG. 4, a seller has an unused item to sell, the seller registers with the transaction APP on a mobile phone, after real-name authentication, the sell may click the “I want to sell goods” button shown on an interface of the APP (with reference to FIG. 5) to input information of the item, the selling price, and then clicks “Next” (with reference to FIG. 6); makes an appointment for the arrival time of the unmanned vehicle (with reference to FIG. 7), and clicks “Call the unmanned vehicle to come” (with reference to FIG. 8), at the same time, the APP sends a shipping request (carrying the arrival time, address and other information) to the transaction server; the transaction server processes the shipping request, searches for an unmanned vehicle near the seller and sends a command (that is, the shipping request); the unmanned vehicle receives the command of the transaction server and autonomously drives to a location designated by the seller; when the unmanned vehicle arrive at the designated location, the seller receives a prompt that the unmanned vehicle arrives; the seller goes to the unmanned vehicle with the item for sale and scans a QR code on the vehicle through the APP to complete authentication (or payment); meanwhile, a video recording device (camera) on the unmanned vehicle is started, the seller places the item in front of designated camera for 360-degree recording of the item (the purpose of this step is to ensure the authenticity and integrity of the item for sale); after the recording is completed, a corresponding compartment door is automatically opened, and the unmanned vehicle issue a voice prompt to let the seller to put the item in the door; after the compartment door is closed, the display screen integrated on the compartment door having item is placed displays the selling price of the item. A middle area of the compartment door is made of transparent glass or other transparent material, which is convenient to display the item during the movement of the unmanned vehicle. Thus, the seller completes the selling operation and the unmanned vehicle drives away.

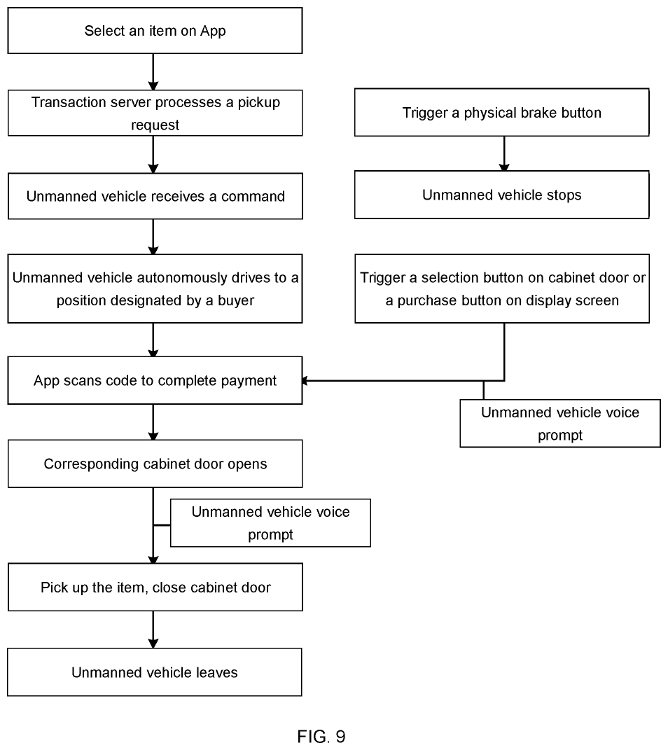

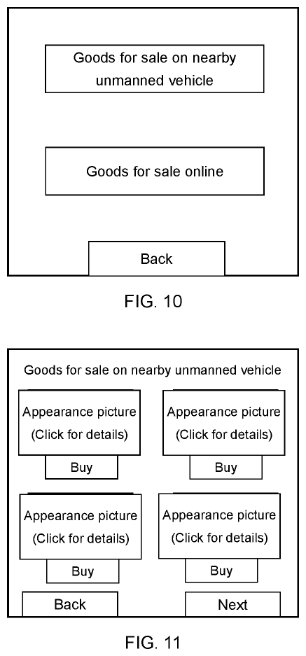

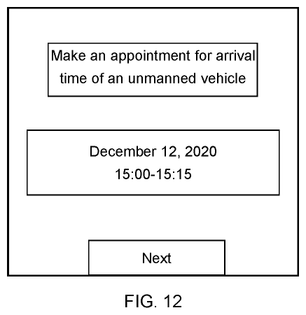

Please continue to refer to FIG. 9, a buyer wants to buy an item, by registering with the transaction APP on a mobile phone, after the real-name authentication, the buyer clicks the “I want to buy goods” button on the APP interface (with reference to FIG. 5); searches for items being sold on a nearby unmanned vehicle(s) through the APP interface for item information (including recorded videos) (with reference to FIGS. 10 and 11); after the buyer finds an item of interest to buy, the buyer clicks a corresponding “Buy” button, makes an appointment for the arrival time of the unmanned vehicle (with reference to FIG. 12), and clicks “Call the unmanned vehicle to come” (with reference to FIG. 8), meanwhile, the APP sends a pickup request to the transaction server (carrying information such as arrival time, address and other information); the transaction server processes the pickup request and sends a command (i.e., the pickup request) to a designated unmanned vehicle (the unmanned vehicle where the item selected by the buyer is placed); the unmanned vehicle receives the command from the transaction server and drives autonomously to a location designated by the buyer; after receiving the reminder that the unmanned vehicle arrives, the buyer goes to the unmanned vehicle to check the item through the compartment door, after confirmation, the buyer presses a selection button on the compartment door, and then scans the QR code on the vehicle through the APP to complete the payment; a corresponding compartment door where the item is stored will automatically open, and the unmanned vehicle voice reminds the buyer to take the item out, the buyer closes the compartment door to complete the purchase operation, and the unmanned vehicle drives away.

Still please refer to FIG. 9, the unmanned vehicle drives autonomously on a designated road, and items for sale are stored in the compartment on the vehicle. The display screen (which may be a touch screen) on the unmanned vehicle shows information of the stored items (including recorded videos, prices, etc.), and the display screen on the corresponding compartment doors also displays the prices. If a person is interested in an item, he/she may go to the vehicle to press the physical brake button on the vehicle. The unmanned vehicle stops. After the buyer checks the item through the compartment door, he/she may press the selection button on the compartment door corresponding to the item, or touch to select the purchase button corresponding to the item shown on the touch screen of the unmanned vehicle. Meanwhile, the display screen of the unmanned vehicle will prompt the code scanning payment information. After the payment is completed, the corresponding compartment door opens, and the unmanned vehicle issues a voice prompt to inform the buyer to take out the item and close the compartment door to complete the purchase operation.

To sum up, the solutions of the present disclosure adding offline transaction options for the online transaction platform, so that users can the items in person, and the transaction efficiency and quality may be improved. Moreover, the unmanned vehicle technology allows performing a transaction at home, making the transaction more convenient.

Furthermore, the combination of the unmanned logistics vehicle and the online transaction platform may not only save costs for physical stores, but also promote the services of the online transaction platform by displaying items on unmanned logistics vehicles.

Therefore, after reading the present detailed disclosure, it will be understood by those skilled in the art that the foregoing detailed description is illustrative, but not restrictive. Those skilled in the art can understand that the present disclosure is intended to cover various r changes, improvements and modifications to the described exemplary embodiments. These changes, improvements and modifications are intended to be proposed by the present disclosure and are within the scope of the present disclosure.

1. An unmanned logistics vehicle, comprising:
a signal transmitting/receiving device in communication with a transaction server to receive target requests, the target requests including
a shipping request to designate a first place for the unmanned logistics vehicle to arrive to load goods in the unmanned logistics vehicle, and
a pickup request to designate a second place for the unmanned logistics vehicle to arrive to deliver goods that has already been loaded in the unmanned logistics vehicle;
a central controller to control the unmanned logistics vehicle to drive to a designated place according to target requests received by the signal transmitting/receiving device;
an on-board compartment to store goods; and
a display device to display information of the goods placed in the on-board compartment.

2. The unmanned logistics vehicle of claim 1, further comprising:
an image-capturing device to collect image information of the goods.

3. The unmanned logistics vehicle of claim 2, wherein
the image-capturing device is further configured to collect image information of a target user, and
the target user is at least one of a user shipping goods or a user picking up goods.

4. The unmanned logistics vehicle of claim 1, further comprising:
a physical brake button to trigger the unmanned logistics vehicle to stop or start.

5. The unmanned logistics vehicle of claim 1, further comprising:
a voice device to issue a voice operation prompt.

6. The unmanned logistics vehicle of claim 1, wherein the on-board compartment includes: a compartment body, a transparent compartment door on which a display screen and a selection button are integrated, and an electric control lock.

7. The unmanned logistics vehicle of claim 1, wherein
the display device is a touch screen.

8. A transaction system, comprising:
a shipping-side client terminal;
a pickup-side client terminal;
a transaction server; and
an unmanned logistics vehicle, wherein
the shipping-side client terminal, the pickup-side client terminal and the unmanned logistics vehicle are each in communication with the transaction server,
the transaction server receives a shipping request of the shipping-side client terminal and forwards the shipping request to the unmanned logistics vehicle, wherein the shipping request is configured to designate a first place for the unmanned logistics vehicle to arrive to load goods in the unmanned logistics vehicle,
the unmanned logistics vehicle receives the shipping request from the transaction server, drives to a first place designated by the shipping-side client terminal to place goods on the unmanned logistics vehicle,
the transaction server further receives a pickup request from the pickup-side client terminal and forwards the pickup request to the unmanned logistics vehicle with the goods, wherein the pickup request is configured to designate a second place for the unmanned logistics vehicle to arrive to deliver goods that has already been loaded in the unmanned logistics vehicle,
the unmanned logistics vehicle with the goods receives the pickup request from the transaction server and drives to a second place designated by the pickup-side client terminal, and
the unmanned logistics vehicle, includes:
a signal transceiving device in communication with the transaction server to receive the shipping request or the pickup request,
a central controller to control the unmanned logistics vehicle to drive to the first place according to the shipping request or the second place according to the pickup request received by the signal transceiving device;
an on-board compartment to store the goods; and
a display device to display information of the goods placed in the on-board compartment.

9. The transaction system of claim 8, wherein
the shipping-side client terminal and the pickup-side client terminal are portable electronic devices or computers in which a transaction service application program is installed.

10. The transaction system of claim 8, wherein the unmanned logistics vehicle including an image-capturing device to collect image information of the goods.

11. The transaction system of claim 10, wherein
the image-capturing device is further configured to collect image information of a target user, and
the target user is at least one of a user shipping goods or a user picking up goods.

12. The transaction system of claim 8, wherein the unmanned logistics vehicle including a physical brake button to trigger the unmanned logistics vehicle to stop or start.

13. The transaction system of claim 8, wherein the unmanned logistics vehicle including a voice device to issue a voice operation prompt.

14. The transaction system of claim 8, wherein the on-board compartment includes:
a compartment body,
a transparent compartment door on which a display screen and a selection button are integrated, and
an electric control lock.

15. The transaction system of claim 8, wherein the display device is a touch screen.

16. A transaction method, comprising:
sending, by a shipping-side client terminal, a shipping request to a transaction server, wherein the shipping request is configured to designate a first place for an unmanned logistics vehicle to arrive to load goods in the unmanned logistics vehicle;
receiving, by the transaction server, the shipping request and forwarding, by the transaction server, the shipping request to an unmanned logistics vehicle;
receiving, by the unmanned logistics vehicle, the shipping request and driving, by the unmanned logistics vehicle, to a first place designated by the shipping-side client terminal;
placing, by a user of the shipping-side client terminal, goods to the unmanned logistics vehicle;
sending, by a pickup-side client terminal, a pickup request to the transaction server, wherein the pickup request is configured to designate a second place for the unmanned logistics vehicle to arrive to deliver goods that has already been loaded in the unmanned logistics vehicle;
receiving, by the transaction server, the pickup request and forwarding, by the transaction server, the pickup request to the unmanned logistics vehicle where the goods are placed; and
receiving, by the unmanned logistics vehicle with the goods, the pickup request and driving, by the unmanned logistics vehicle with the goods to a second place designated by the pickup-side client terminal.

17. The transaction method of claim 16, further comprising:
collecting, by an image-capturing device on the unmanned logistics vehicle, image information of the user of the shipping-side client terminal and the goods placed by the user.

18. The transaction method of claim 16, further comprising:
opening, by the unmanned logistic vehicle, a compartment door of an on-board compartment with the goods on the unmanned logistics vehicle upon receiving from the pickup-side client terminal a confirmation of the goods placed on the unmanned logistics vehicle.

19. The transaction method of claim 16, further comprising:
stopping the unmanned logistics vehicle upon a brake button integrated on the unmanned logistics vehicle being pressed by a user who observes information of a goods of interest through a display device on the unmanned logistics vehicle.

20. The transaction method of claim 19, further comprising:
opening a compartment door of the on-board compartment corresponding to the goods of interest upon the user selecting the item of interest.
